(19) United States
(12) Patent Application Publication
(10) Pub. No.: US 2023/0392367 A1
(43) Pub. Date: Dec. 7, 2023

(54) High Capacity Beam Hanger

(71) Applicant: Simpson Strong-Tie Company Inc, Pleasanton, CA (US)

(72) Inventors: Larry Randall Daudet, Brentwood, CA (US); Timothy Patrick Murphy, Tracy, CA (US); Michael D Weinert, Seattle, WA (US)

(21) Appl. No.: 18/206,566

(22) Filed: Jun. 6, 2023

Related U.S. Application Data
(60) Provisional application No. 63/349,545, filed on Jun. 6, 2022.

(51) Int. Cl. E04B 1/26

(52) U.S. Cl. CPC E04B 1/2604; E04B 2001/2636; E04B 2001/2648

(57) ABSTRACT

A connector joins a beam to a header, the connector has two members with mating portions. The mating members are provided with projections and slots that engage each other and transmit gravity loads between the members.

### BACKGROUND OF THE INVENTION

This invention relates to a concealed hanger for making a connection between a header and a beam, or other structural members.

Generally, a header and a beam meet at a right angle although other orientations are possible, especially in constructing sloped roofs and attaching staircase stringers to headers. Connectors for making this connection are often called hangers. There are many different connectors for attaching a beam to a header. Some like the present invention are designed to be generally hidden from view. Others may be exposed or have portions that are exposed on the surfaces of the members. Typically, exposed hangers wrap underneath the beam or the supported member.

There are many patented and un-patented concealed hangers. U.S. Pat. No. 2,793,407, invented by J. W. Johnston and granted in 1957, teaches a concealed connector made from sheet metal. The connector consists of a pair of flanged members that engage each other with each member of the pair being attached to one of the structural members to be connected. A male dovetailed member slides into a slot in the female dovetailed member. Johnston teaches providing the flanges of the female mating dovetailed member with openings or apertures that receive protuberances or knobs on the outer surface of the flanges of the male mating dovetailed member. In Johnston, the male member is made of a material that can flex slightly to allow the protuberances to slip past and then engage the apertures of the female member. According to Johnston this engagement firmly locks the male dovetailed member within the female dovetailed member.

US Patent Publication 2007/0154257 A1, invented by Ove K. Guttormsen and published in 2007, teaches a concealed connector made from sheet metal. The connector consists of a pair of flanged, mating members having wedged or dovetailed sections that engage each other. Guttormsen teaches providing each member of the connector with a generally horizontally disposed ledge or shoulder that abuts a corresponding ledge or shoulder on the other member. According to Guttormsen this abutment of these shoulders prevents the male component from penetrating wedgingly so far into the female component as to deform and weaken the female component.

U.S. Pat. No. 7,004,436, invented by Friedrich Knapp and granted in 2006, teaches a concealed connector made from sheet metal. The connector consists of a pair of members that engage each other with each member of the pair being attached to one of the structural members to be connected. Each member is formed with a u-shaped, return flange that receives and engages with an end portion of the other connector, and the return flange of each member also receives a fastener that is received in a slot of the end portion of the other member.

EP Patent 1 856 417, invented by Friedrich Knapp and granted in 2013, teaches a concealed connector made from metal. The connector is made from a pair of members that engage each other. At least one of the members has a shaft or pin with a head that is received in a flared notch or slot formed in the other member so that member with the head supports the member with a recess.

EP Patent Application 3 456 892 A1, invented by Friedrich Knapp and published in 2019, teaches a concealed connector made from sheet metal. The connector is made from a pair of mating members, each having shoulder portions that engage the end of the other member, and each has a shaft or pin with a head that engages a slot or notch in the other member. The corresponding U.S. Pat. No. 10,968,621 issued in 2021.

The present invention provides a concealed hanger that is easy to install, economical to produce and creates a strong connection with little movement between the members.

### SUMMARY OF THE INVENTION

It is an object of the present invention to provide a connection between a first structural member and a second structural member, as between a header and a beam. It is a further object to provide a connection that resists tension and compression loading as well as gravity loads. It is a further object of the present invention to provide a connection that is easily adapted to present building practices and wherein the connector is generally hidden from view.

According to the present invention, the connector is made from two members that matingly engage each other with each member being attached to one of the structural members to be connected. The connector is preferably made from metal. The connector has a longitudinal axis that extends along the connector from the top portion of the connector to the bottom portion of the connector. The connector is designed to resist bending.

The present invention can be a connection between adjacent first and second structural members such as a header and a beam. The connection is made with a two-piece connector and a first fastening and a second fastening. Preferably, the first member is attached to a beam or a joist by one or more fasteners and the second member is attached to the header by one or more fasteners. Each member is formed with a body that receives the fasteners. Each member of the connector has a projection that matingly engages with a slot formed in the body of the other member. Each projection corresponds in dimension to the slot with which it engages.

According to the present invention, preferably each of the members of the connector is attached to one of the structural members that make up the connection with one or more fasteners that enter the structural member at an acute angle to the longitudinal axis. This improves the connection of the member to the structural member as the fastener penetrates through many layers of the structural member if it is made from wood, and the fastener is at an inclined angle to pull-out forces.

According to the present invention, the members of the connector are formed with shoulders or flanges disposed in interfacing relation along a columnar axis disposed generally orthogonally to the bodies of the members and orthogonally to the longitudinal axis. In certain instances this columnar axis is generally aligned with some of the fasteners that connect the connector members to the first and second structural members.

According to the present invention, the connector members are made with opposed end edges at the top and bottom portions of the connector along the longitudinal axis, and the projection is formed near one end edge, preferably beginning at the end edge, and the slot is formed at the opposed end edge. The projection and the slot extend from the end edges toward the middle of the connector. Preferably, the connector is substantially longer along the longitudinal axis than the combined lengths along the longitudinal axis of the projection and the slot. The connector members of the connector are preferably identical, and when the connector members are oriented along the longitudinal axis in opposite manners they will matingly engage each other.

According to the present invention, when a connector member is oriented along the longitudinal axis with the projection of the connector member located above the slot of the same connector member, the fasteners that are set at an acute angle to the generally planar body of the connector member which they engage are directly downwardly with respect to the longitudinal axis with the tips of the fasteners being below the heads of the fasteners. According to the present invention, the majority of the fasteners received by a connector member are disposed at an acute angle with respect to the longitudinal axis of the connector member. Preferably each connector member is attached to a structural member with most of the fasteners set at an acute angle to the longitudinal axis. According to the preferred form of the invention, one of the fasteners passes through the projection at an acute angle to the longitudinal axis with the tip of the fastener directed toward the center of the connector member when it is driven through the projection. According to the present invention, one of the fasteners passes through the projection at an orthogonal angle to the longitudinal axis. According to the present invention, most of the fasteners received by the connector member at an angle orthogonal to the longitudinal axis are disposed either near the projection, or the slot with the fasteners set at an acute angle to the longitudinal axis being disposed near the center portion of the connector member.

According to the present invention the projection is formed with opposed side edges that extend parallel to the longitudinal axis and the side edges extend to the end edge of the connector member. According to the present invention each connector member has a meshing face that is disposed adjacent or abutting the meshing face of the other connector member when the connection is made. Preferably the meshing faces are substantially planar with the projections jutting from the meshing faces. The connector members are also preferably formed with opposed attachment faces that interface with or substantially abut the attachment faces of the structural members. Preferably, the projection extends away from the structural member to which the connector member is attached and away from the meshing face of the connector member of which it is a part. The projection member does enter the structural member to which the connector member is attached.

Preferably, the opposed sides of the slot of the connector member flare outwardly as the approach the edge of the connector member to make formation of the connection easier, and the slot starts at the end edge of the connector member. Preferably the end of the projection closer to the middle of the connector member is semi-circular and it engages an end of the slot close to the middle of the connection member that is semi-circular.

### BRIEF DESCRIPTION OF THE DRAWINGS

FIG. 1 is a perspective view of the connector according to the present invention.

FIG. 2 is a front perspective view of one of the members of the connector of FIG. 1.

FIG. 3 is a back perspective view of one of the members of the connector of FIG. 1.

FIG. 4 is a perspective view of one member of the connector according to the present invention, ready to be attached to a structural member with fasteners.

FIG. 5 is perspective view of one member of the connector according to the present invention, attached to a structural member with fasteners.

FIG. 6 is perspective view of one member of the connector according to the present invention, ready to be attached to a structural member with fasteners.

FIG. 7 is perspective view of one member of the connector according to the present invention, attached to a structural member with fasteners.

FIG. 8 is a perspective of the connection of the present invention ready to be made with one of the structural members shown in dotted lines to show the connector.

FIG. 9 is a perspective of the connection of the present invention with one of the structural members shown in dotted lines to show the connector.

FIG. 10 is a front view of one of the members of the connector of the present invention.

FIG. 11 is a back view of the member of the connector shown in FIG. 10.

FIG. 12 is a right, side view of the member of the connector shown in FIG. 10.

FIG. 13 is a left, side view of the member of the connector shown in FIG. 10.

FIG. 14 is a top view of the member of the connector shown in FIG. 10.

FIG. 15 is a bottom view of the member of the connector shown in FIG. 10.

### DESCRIPTION OF THE PREFERRED EMBODIMENT

The present invention is a connection between a first structural member 1 such as a joist or beam and a second structural member 2 such as a header or post. The connection is designed to resist gravity loads and tension and compression loads between the first structural member 1 and the second structural member 2. Preferably, the first structural member 1 has an attachment face 3, and the second structural member 2 has an attachment face 4. In one preferred embodiment of the invention, the attachment faces 3 and 4 are generally planar members disposed generally parallel and adjacent to each other when the connection is formed. The first structural member 1 and the second structural member 2 are positively joined by the substantially rigid connector 5 of the present invention.

The first structural member 2 is typically made from wood, but it could also be any building material used to create the structural frame of a building. The first structural member 2 could also be made from steel. The second structural member 3 is also typically made from wood, but it can be made from steel, or it can also be a cementitious member or a brick wall.

In order to better define the invention, the connector 5 is described as having a longitudinal axis 6. A first preferred embodiment of the connection of the present invention used to join the first structural member 1 and the second structural member 2 also includes one or more fasteners 7 received by the elongated connector 5 and the first and second structural members 1 and 2. The preferred fasteners 7 are preferably screws when the first structural members are made from wood.

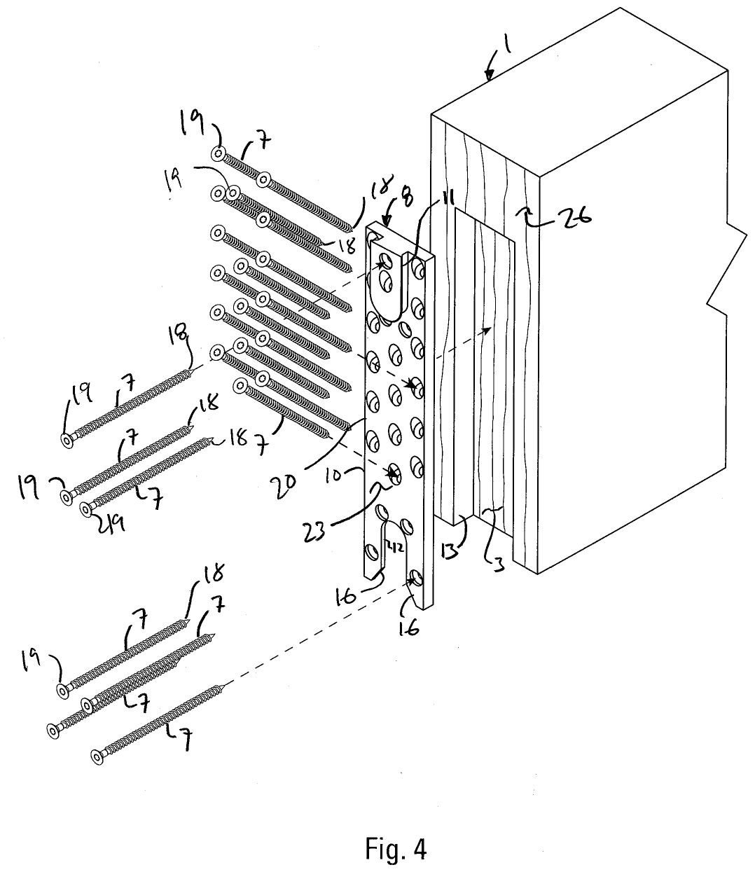

The elements of the connection are preferably arranged in the following manner. The connection is formed with the attachment face 3 of the first structural member 1 and the attachment face 4 of the second structural member 2 disposed in close proximity to each other. The connector 5 has a first connector member 8 attached to the attachment face 3 of the first structural member 1 and a second connector member 9 attached to the attachment face 4 of the second structural member 2. The first and second connector members 8 and 9 of the connector are joined together when the connection is made. As shown in FIG. 4, the end 3 of the first structural member 1 can have a notch 13 or recess or cut-out portion so that first connector member 8 sits within the notch and the attachment face 3 of the beam 1 can interface with the attachment face 4 of the second structural member 2. Alternatively, the header 2 can be notched and the second connector member 9 could be disposed in the notch.

The first connector member 8 has a body 10 and one or more projections 11 extending from the body 10. The first connector member 8 is also formed with one or more slots 12 in the body 10. Similarly, the second connector member 9 has a body 10 and one or more projections 11 extending from the body 10, and one or more slots 12 formed in the body 10. The first connector member 8 is joined to the second connector member 9 by operation of the projections 11 matingly engaging with slots 12.

The connection is made with a two-piece hanger or connector 5 and a first fastening and a second fastening. The first connector member 8 is preferably attached to the first structural member 1 by one or more fasteners 7, constituting the first fastening. The second member 9 is attached to the second structural member 2 by one or more fasteners 7, constituting the second fastening. Each member 8 or 9 is formed with a body 10 that receives the fasteners 7. The bodies 10 are preferably formed with fastener openings 14 to receive the fasteners 7.

According to the present invention, the connector 5 is preferably formed with angled openings 15 for some of the fasteners 7 to accommodate the angle of the fasteners 7 with respect to the connector members 8 and 9.

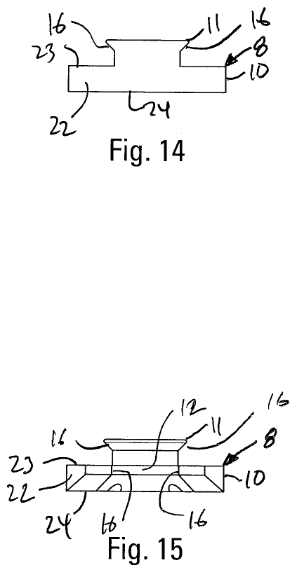

As shown in FIGS. 14 and 15, projecting flanges 16 or shoulders are preferably formed on the edges of the slots 12 and on the edges of the projections 11 to engage each other. According to the present invention, each of the connector members 8 and 9 of the connector 5 is made with portions that have shoulders or flanges 16 disposed generally transverse to the longitudinal axis 6 that will abut with or lie closely adjacent to shoulders or flanges 16 on the other member of the connector 5.

According to the present invention, the connector members 8 and 9 of the connector 5 are formed with overlapping portions 16 disposed in interfacing or closely adjacent relation along a columnar axis 17 disposed generally orthogonally to the bodies 10 of the members 8 and 9. In certain instances this columnar axis 17 is generally aligned with some of the fasteners 7 that connect the members 8 and 9 to the first and second structural members 1 and 2.

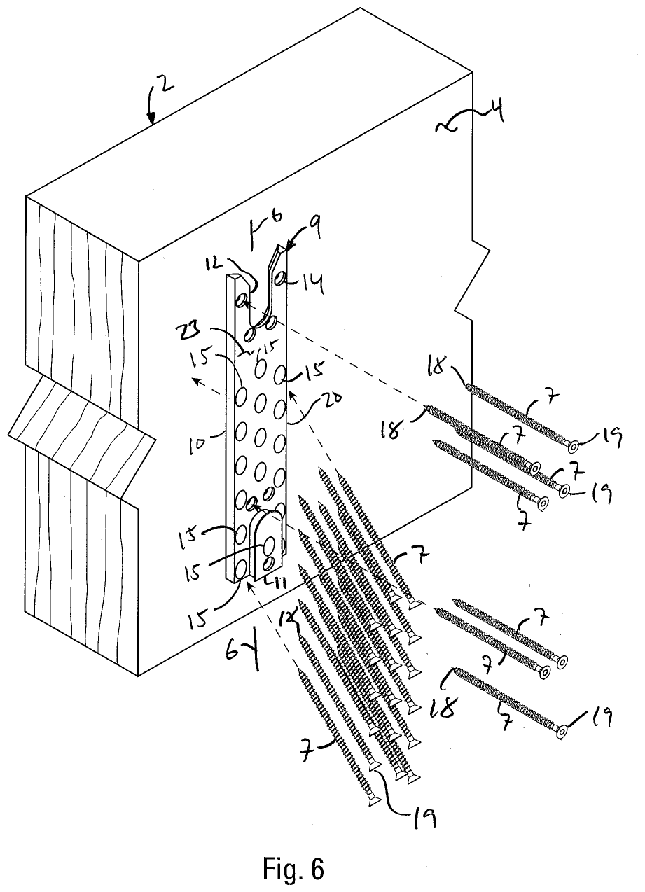

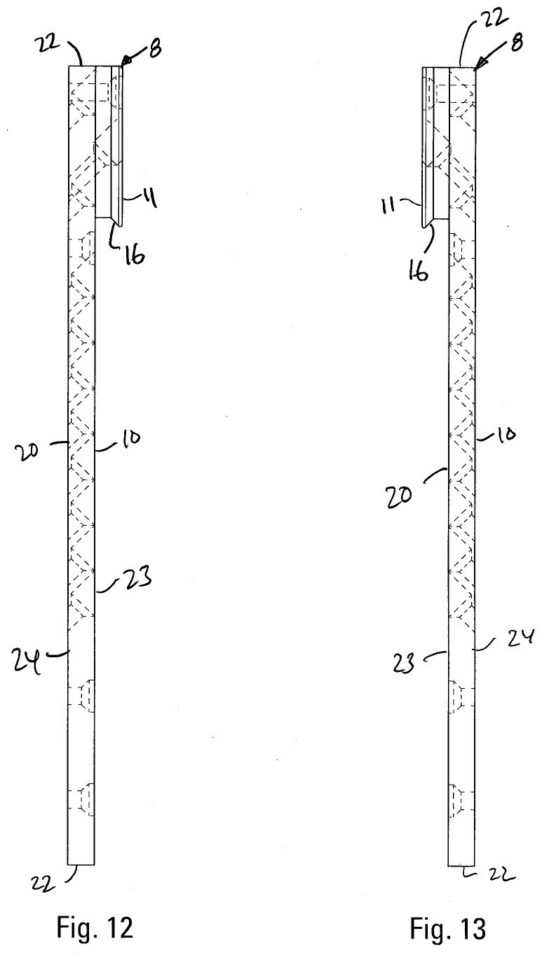

Each connector member 8 and 9 of the connector 5 has angled openings 15 that can receive fasteners 7 disposed at an inclined angle to each of the members 8 and 9 of the connector. These angled fasteners 7 enter the generally planar attachment face 4 of the second structural member 2 at a non-orthogonal angle to the planar attachment face 4. Fasteners 7 that are orthogonal to the generally planar body 10 of member 9 pass through connector member 9 with the tips 18 of the fasteners 7 passing through body 10 and then entering the second structural member 2. As shown in FIGS. 6, 12 and 13, the orthogonal fasteners 7 can be formed with heads 19 with sloped undersides that could engage openings 14 in body 10 that have similarly sloped surfaces so the head of the fastener 7 can sit flush with the upper surface of planar body 10. The angled fastener openings 15 can have be similarly shaped with sloped surfaces to engage the underside of heads 19 of fasteners 7 that have sloped undersides.

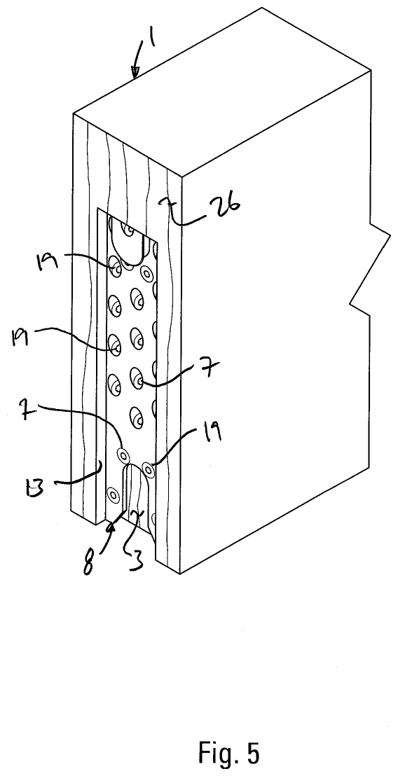

As shown in FIG. 5, according to the present invention, when a connector member 8 is oriented along the longitudinal axis 6 with the projection 11 of the connector member 8 located above the slot 12 of the same connector member 8, the fasteners 7 that are set at an acute angle to the generally planar body 10 of the connector member 8 which they engage are directed downwardly with respect to the longitudinal axis 6 with the tips 18 of the fasteners 7 being below the heads 19 of the fasteners 7. As shown in FIG. 6, when the connector member 9 has an opposed orientation, the fasteners 7 also have an opposed orientation with the tips 18 of the fasteners 7 driven at an acute angle to the longitudinal axis 6, being disposed above the heads 19 of the fasteners 7.

As shown in FIGS. 4 and 6, according to the present invention, the majority of the fasteners 7 received by a connector member 8 or 9 are disposed at an acute angle with respect to the longitudinal axis 6 of the connector member 8 or 9. Preferably each connector member 8 or 9 is attached to a structural member 1 or 2 with a majority of the fasteners 7 set at an acute angle to the longitudinal axis 6.

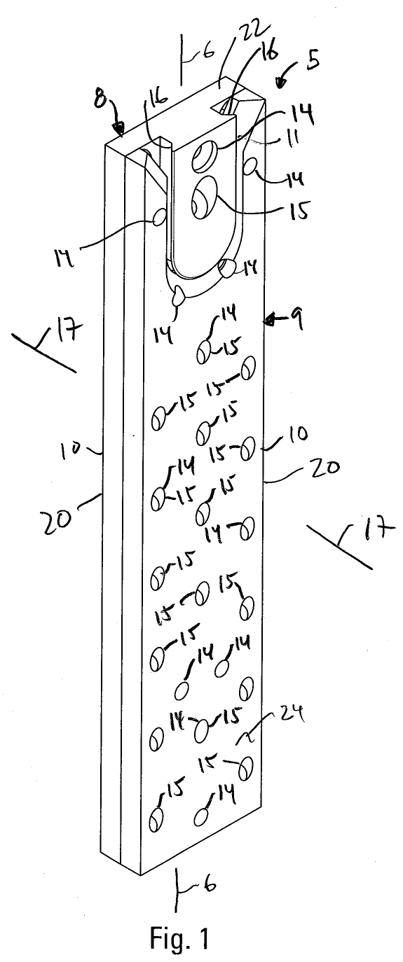

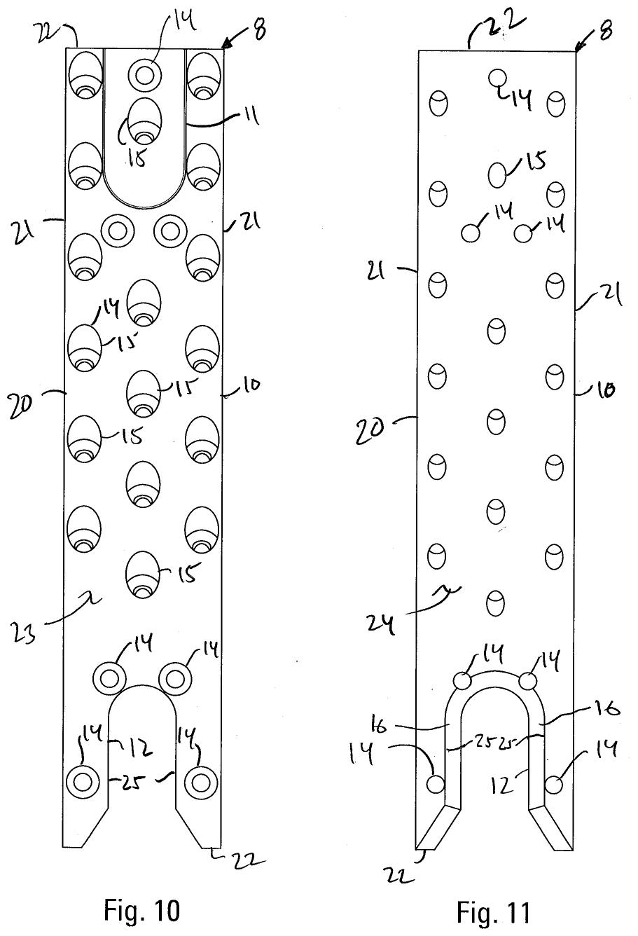

As best shown in FIGS. 1, 4, 9, 10, 11, 12 and 13, according to the preferred form of the invention, one of the fasteners 7 passes through the projection 11 at an acute angle to the longitudinal axis 6 with the tip 18 of the fastener directed toward the center portion 20 of the connector member 8 or 9 when the tip 18 of the fastener 7 enters the connector member 8 or 9. According to the present invention, one of the fasteners 7 passes through the projection at an orthogonal angle to the longitudinal axis 6 and parallel to the columnar axis 17.

According to the present invention, the fasteners 7 received by the connector member 8 or 9 at an angle orthogonal to the longitudinal axis 6 are disposed near the projection 11 and the slot 12 with the fasteners 7 set at an acute angle to the longitudinal axis 6 being disposed near the center portion 20 of the connector member 8 or 9.

According to the present invention, the connector members 8 and 9 are made with opposed end edges 22 along the longitudinal axis 6, and the projection 11 is formed near one end edge 22, preferably beginning at the end edge 22, and the slot 12 is formed at the opposed end edge 22. The projection 11 and the slot 12 extend from the end edges 22 toward the middle or center portion 20 of the connector member 8 or 9. Preferably, the connector member 8 or 9 is substantially longer along the longitudinal axis 6 than the combined lengths along the longitudinal axis 6 of the projection 11 and the slot 12. The connector members 8 and 9 of the connector 5 are preferably identical, and when the connector members 8 and 9 are oriented along the longitudinal axis 6 in opposite manners they will matingly engage each other, as shown in FIG. 1.

As shown in FIGS. 14 and 15, according to the present invention the projection 11 is formed with opposed side edges 21 that have portions that extend parallel to the longitudinal axis 6 and the side edges 21 extend to the end edge 22 of the connector member 8 or 9. According the present invention each connector member 8 or 9 has a meshing face 23 that is disposed adjacent or abutting the meshing face 23 of the other connector member 8 or 9 when the connection is made. Preferably the meshing faces 23 are substantially planar with the projections 11 jutting from the meshing faces. The connector members 8 or 9 are also preferably formed with opposed attachment faces 24 that interface with or substantially abut the attachment faces 3 and 4 of the structural members 1 and 2. Preferably, the projection 11 extends away from the structural member 1 or 2 to which the connector member 8 or 9 is attached and away from the meshing face 23 of the connector member of which it is a part. The projection 11 does enter the structural member 1 or 2 to which the connector member 8 or 9 is attached.

Preferably, the slot 12 is formed with opposed side edges 25 that have parallel portions that extend in line with the longitudinal axis 6 and can closely interface with the opposed side edges 21 of the projection 11. Near the end edge 22 of the connector member 8 or 9 the side edges 25 of the slot 12 flare outwardly as the approach the end edge 22 to make formation of the connection easier. Preferably the slot 12 starts at the end edge 22 of the connector member 8 or 9. Preferably the end of the projection 11 closer to the middle of the connector member is semi-circular and it engages the end of the slot 12 closer to the middle of the connector member that is semi-circular.

FIG. 1. shows connector members 8 and 9 in mating contact with the shoulders or flanges 16 of the projection 11 engaging the shoulder or flanges of the slot 12. Fasteners 7 are not shown received in fastener openings 14.

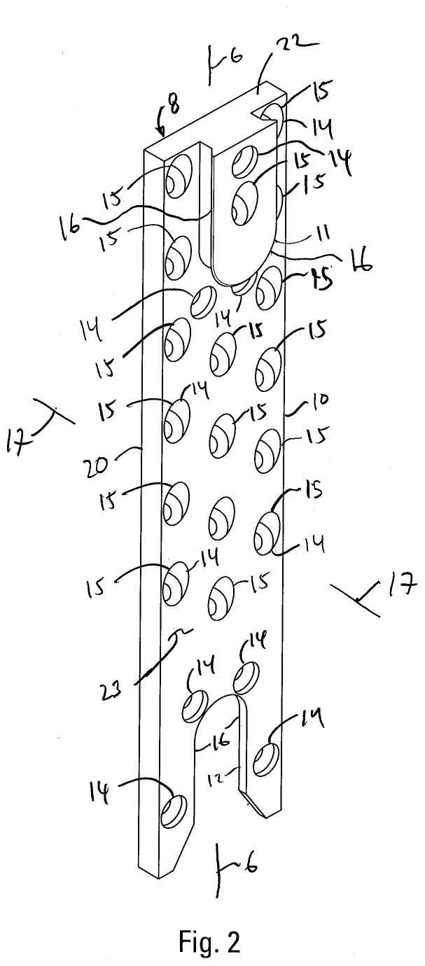

FIG. 2. shows a connector member 8 that will be attached to the first structural member 1 with the projection 11 oriented above the slot 12. This particular connector member 8 is shown with seventeen angled fastener openings 14 and seven fastener openings 15 that will receive fasteners 7 that are aligned or parallel with the columnar axis 17. In the projection 11, the angled fastener opening 15 is disposed closer to the center portion 20 of the connector member than the fastener opening 15 for a fastener that will be disposed parallel to the columnar axis 17.

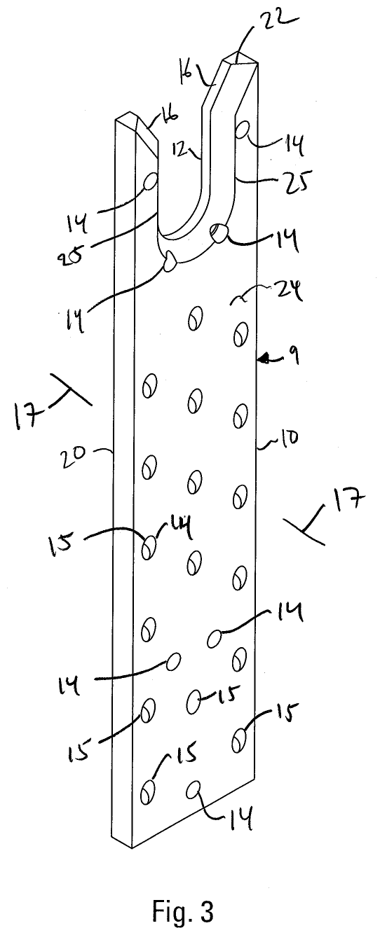

FIG. 3 shows a connector member 9 that will be attached to the second structural member 2 with the slot 12 oriented above the projection 11 (not shown). In this orientation, this connector member 9 can matingly engage with the connector member 8 shown in FIG. 2, as shown in FIG. 1.

FIG. 4. shows the recess 13 in the end 26 of the first structural member 1 with the connector member 8 ready to be inserted into the recess 13 and attached to the first structural member 1 with fasteners 7. FIG. 5 shows connector member 8 attached to first structural member 1.

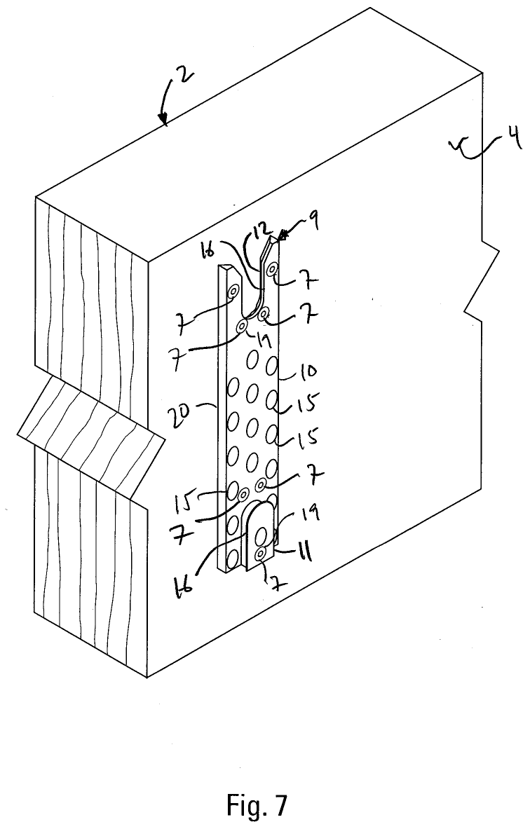

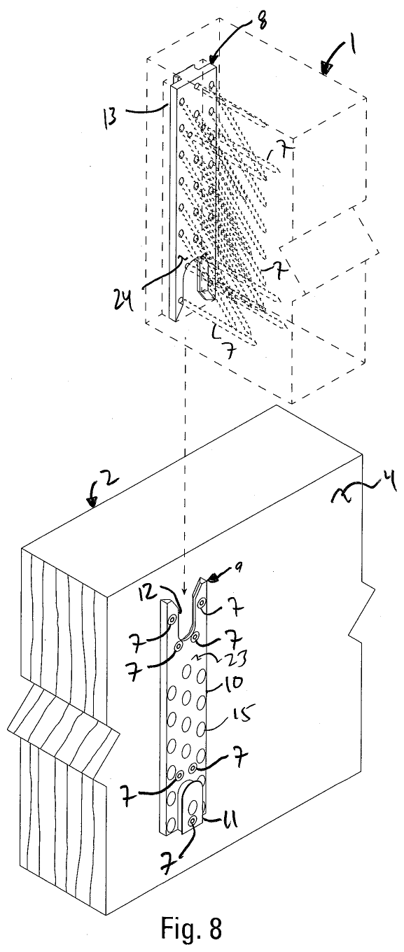

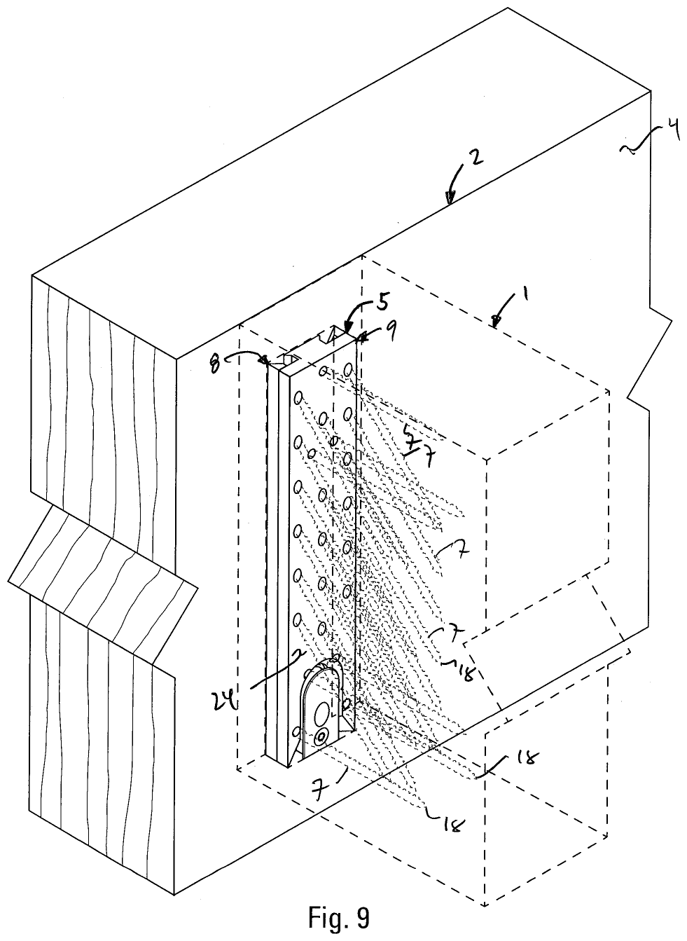

FIG. 6 shows connector member 9 set against the attachment face 4 of the second structural member 2 and ready to be attached to second structural member 2 with fasteners 7. FIG. 7 shows connector member 9 attached to second structural member 2. FIG. 8 shows the first structural member 1 (in dotted lines) ready to be slid into place and attached to second structural member 2 by means of the connector 5. FIG. 9 shows the connection with the fastener 7 attaching connector member 8 to the first structural member in dotted lines.

The connection is made by attaching connector member 8 to structural member 1 with fasteners 7 and connecting connector member 9 to structural member 2 with fastener 7. Then the connectors 8 and 9 are brought together so that slots in each connector member 8 or 9 receive the projection of the other connector member 8 or 9. Connector members 8 and 9 are preferably machined metal parts as from aluminum.

1. A connection between a first structural member and a second structural made with a connector, the connection comprising:
a. the first structural member having an attachment face;
b. the second structural member having an attachment face that is disposed in close relation to the attachment face of the first structural member and is generally parallel with the attachment face of the first structural member;
c. the connector, the connector having a first connector member attached to the first structural member, and a second connector member attached to the second structural member, the first and second connector members having a longitudinal axis that extends from a top portion of the first and second connector members to a bottom portion of the first and second connector members; the first connector having one or more projections and the second connector member having one or more projections, and
d. the first connector member has one or more elongated slots that receive the one or more projections of the second connector member, and the second connector member has one or more elongated slots that receive the one or more projections of the first connector member.

2. The connection of claim 1, wherein:
a. the connector is formed with a columnar axis that is orthogonal to the longitudinal axis and generally orthogonal to the parallel attachment faces of the first and second structural members; and
b. the first and second connector members of the connector are formed with shoulders or flanges disposed in interfacing relation along the columnar axis that is disposed generally orthogonally.

3. The connection of claim 1, wherein:
a. the first and second connector members are attached to the first and second structural members with elongated fasteners; and
b. the columnar axis is generally aligned with some of the elongated fasteners that connect the connector members to the first and second structural members.

4. The connection of claim 1, wherein:
a. the first connector member is formed with a body, and the body has one or more openings that receive one or more angled fasteners that are received by the first structural member; and
b. the second connector member is formed with a body, and the body has one or more openings that receive one or more angled fasteners received by the second structural member.

5. The connection of claim 4, wherein:
a. the one or more angled fastener received in the first structural member enter a generally planar attachment face of the first structural member at a non-orthogonal angle to the generally planar attachment face; and
b. the one or more angled fastener received in the second structural member enter a generally planar attachment face of the second structural member at a non-orthogonal angle to the generally planar attachment face.

6. The connection of claim 5, wherein:
a. the first connector member is also attached to the first structural member with one or more fasteners set orthogonally to the generally planar attachment face of the first structural member; and
b. the second connector member is also attached to the second structural member with one or more fasteners set orthogonally to the generally planar attachment face of the second structural member.

7. The connection of claim 4, wherein:
a. the one or more openings that receive the one or more angled fasteners in the body of the first connector member are angled openings; and
b. the one or more openings that receive the one or more angled fasteners in the body of the second connector member are angled openings.

8. The connection of claim 1, wherein:
the first and second connector members are made with opposed end edges at the top and bottom portions of the connector along the longitudinal axis, and the one or more projections are formed near one end edge, and the one or more slots are formed at the opposed end edge.

9. The connection of claim 8, wherein:
the one or more projections and the one or more slot extend from the end edges toward the middle of the connector.

10. The connection of claim 9, wherein:
a. the connector members are substantially longer along the longitudinal axis than the combined lengths along the longitudinal axis of the one or more projections and the one or more slots.

11. The connection of claim 10, wherein:
a. the connector members of the connector are preferably identical; and
b. the connector members are oriented along the longitudinal axis in opposed manners such that they matingly engage each other.

12. The connection of claim 4, wherein:
a. one of the connector members is oriented along the longitudinal axis with the one or more projections of the connector member located above the one or more slots of the same connector member;
b. the one or more angled fasteners have tips and opposed heads with the one or more tips being the first part of the one or more angled fasteners that is driven into the first or second structural members; and
b. the one or more angled fasteners that are set at an acute angle to the generally planar attachment face which they engage are directly downwardly with respect to the longitudinal axis with the tips of the one or more angled fasteners being below the heads of the one or more angled fasteners.

13. The connection of claim 12,
the majority of the one or more fasteners received by the first and second connector members are disposed at an acute angle with respect to the longitudinal axis of the connector member.

14. The connection of claim 4, wherein:
at least one of the one or more fasteners passes through each of the one or more projections of each of the first and second connector members at an acute angle to the longitudinal axis.

15. The connection of claim 14, wherein:
a. the first and second connector members are formed with central portions between the top and bottom portions of the first and second connector members
b. the one or more angled fasteners have tips and opposed heads with the one or more tips being the first part of the one or more angled fasteners that is driven into the first or second structural members; and
c. the tip of the at least one of the one or more angled fasteners that pass through each of the one or more projections of each of the first and second connector members is directed toward the center of the connector member.

16. The connection of claim 15,
a. the first connector member is also attached to the first structural member with one or more fasteners set orthogonally to the generally planar attachment face of the first structural member; and
b. the second connector member is also attached to the second structural member with one or more fasteners set orthogonally to the generally planar attachment face of the second structural member;
c. and at least one of the one or more fasteners set orthogonally to the generally planar attachment face of the first structural member that attaches the first connector member passes through each of the one or more protrusions of the first connector member; and
d. at least one of the one or more fasteners set orthogonally to the generally planar attachment face of the second structural member that attaches the second connector member passes through each of the one or more protrusions of the first connector member.

17. The connection of claim 1, wherein
the first and second connector members each has meshing face that is disposed adjacent or abutting the meshing face of the other connector member.

18. The connection of claim 18, wherein:
the meshing faces are substantially planar with the one or more projections jutting from the meshing faces.

19. The connection of claim 19, wherein:
a. the one or more projections of the first connector member extend away from the attachment face of the first structural member and away from the meshing face of the first connector member; and
b. the one or more projections of the second connector member extend away from the attachment face of the second structural member and away from the meshing face of the second connector member.

20. The connection of claim 20, wherein:
the one or more projection members do not enter the first or second structural members.
